(19) United States
(12) Patent Application Publication
(10) Pub. No.: US 2024/0088351 A1
(43) Pub. Date: Mar. 14, 2024

(54) SILICON-CARBON COMPOSITE FIBER

(71) Applicant: UNIFRAX I LLC, Tonawanda, NY (US)

(72) Inventors: Donghui ZHAO, Amherst, NY (US); Bruce K. ZOITOS, Williamsville, NY (US); Wenbo CHENG, Getzville, NY (US); Adam KELSALL, Williamsville, NY (US); Chad D. CANNAN, Spring, TX (US)

(21) Appl. No.: 17/906,770

(22) PCT Filed: Sep. 2, 2022
(86) PCT No.: PCT/US2022/075876

§ 371 Date: Sep. 20, 2022

Related U.S. Application Data
(60) Provisional application No. 63/242,525, filed on Sep. 10, 2021.
(60) Provisional application No. 63/240,135, filed on Sep. 2, 2021.

(51) Int. Cl. H01M 4/36; C04B 35/628; C04B 35/64; C04B 35/80; D01F 9/12; H01M 4/38; H01M 4/583

(52) U.S. Cl. CPC H01M 4/364; C04B 35/62873; C04B 35/62886; C04B 35/64; C04B 35/80; D01F 9/12; H01M 4/386; H01M 4/583; D10B 2505/00; H01M 2004/021

(57) ABSTRACT

A composite fiber includes a porous silicon phase including elemental silicon and a porous carbon phase including elemental carbon. The silicon phase and the carbon phase form an intertwined network structure in the composite fiber such that each of the silicon phase and the carbon phase is interconnected and continuous throughout the composite fiber. The silicon phase and the carbon phase together constitute at least 50 wt % of the composite fiber.

### CROSS REFERENCE TO RELATED APPLICATIONS

This application claims priority to U.S. Provisional Patent Application No. 63/240,135 filed Sep. 2, 2021 and titled “SILICON-CARBON COMPOSITE FIBER” and U.S. Provisional Patent Application No. 63/242,525 filed Sep. 10, 2021 and titled “SILICON-CARBON COMPOSITE FIBER,” each of which are hereby incorporated by reference in their entireties.

### FIELD OF THE DISCLOSURE

The present disclosure relates to a silicon-carbon composite fiber and methods of making and using the same.

### BACKGROUND

Lithium ion batteries have proliferated in the last decade and now are the power source of choice for providing portable power to electronic devices, cordless equipment and vehicles. As technology has become increasingly reliant on lithium-ion battery power, the lithium-ion battery industry has worked to extend the performance of their cells in order to provide maximum versatility to the end user.

Graphite is commonly used in lithium-ion cells, due to its ability to remain stable and serve its function over multiple hundreds of cycles with little to no capacity loss. Silicon shows great promise as an anode material, due to its extremely high capacity (4000 mAh/g) relative to graphite (372 mAh/g), which is the current industry standard. However, silicon has the limitation of swelling 350% upon lithiation. This swelling can cause severe disruption of the internal cell structure and result in rapid loss of capacity as cell components are damaged and the anode grinds itself into smaller pieces and ultimately loses electrical connectivity. Thus, there is a continuing need for improved silicon-containing anode materials and methods of preparing such silicon-containing anode materials.

### BRIEF DESCRIPTION OF THE DRAWINGS

Various embodiments of the present disclosure will be understood more fully from the detailed description given below and from the accompanying drawings. In the drawings, like reference numbers may indicate identical or functionally similar elements. Embodiments are described in detail hereinafter with reference to the accompanying figures, in which:

FIG. 1 is an illustration showing differences between fast and slow lithium-ion transport on a composite fiber according to embodiments of the present disclosure.

FIG. 2 is an SEM image of the cross-section of a porous silicon fiber template (PSFT) according to embodiment of the present disclosure.

FIG. 3 is two STEM images of the cross-section of a Si—C composite fiber according to an embodiment of the present disclosure.

FIG. 4 is elemental mapping of the cross-section of the Si—C composite fiber by STEM-EELS according to an embodiment of the present disclosure.

FIG. 5 is a graph showing the relationship between 1^{st} cycle specific lithiation capacity, 1^{st} cycle coulombic efficiency (FCE), and carbon content (C wt %) for composite fibers according to embodiments of the present disclosure.

FIG. 6 is a graph showing the relationship between pore volume and crystalline silicon content in PSFTs according to embodiments of the present disclosure.

FIG. 7 is a graph showing the relationship between specific delithiation capacity, FCE, and C % according to embodiments of the present disclosure.

FIG. 8 is a graph showing the relation between normalized capacity and C % according to embodiments of the present disclosure.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The present disclosure provides a silicon-carbon composite fiber (“Si—C composite fiber” or “composite fiber”) comprising a silicon phase (“Si phase”) and a carbon phase (“C phase”). The Si and C phases form an intertwined network structure in the fiber, where each of the phases is interconnected and continuous throughout the fiber. The Si phase comprises nano-crystalline or amorphous elemental silicon. The Si phase is present in the fiber in a range of greater than 0 wt % to less than 100 wt %. The C phase comprises amorphous or crystalline carbon and is present in the fiber in a range of greater than 0 wt % to less than 100 wt %. In some embodiments, a sum of the Si and C phases is in a range of 50 wt % to 100 wt %. In some embodiments, the C phase comprises at least 30 wt % of the fiber and/or the Si phase comprises at least 20 wt % of the fiber.

In some embodiments, the composite fiber comprises carbon in an amount of at least 29 wt %, at least 35 wt %, 37 wt %, at least 39 wt %, at least 40 wt %, at least 41 wt %, at least 42 wt %, at least 43 wt %, at least 44 wt %, at least 45 wt %, at least 46 wt %, 29 to 63 wt %, 37 to 63 wt %, 39 to 63 wt %, or 46 to 63 wt %.

Where the carbon content in the composite fiber is represented by Xc (in wt %, based on a total weight of the composite fiber) and the content of elemental silicon (excluding silica) in the composite fiber is represented by Xsi (in wt %, based on a total weight of the composite fiber), the composite fiber may be characterized by the following Formula 1 and Formula 2:

Xsi/(100-Xc) [Formula 1]

0.3025*Xc+3.70*Xsi/(100-Xc)+57.97 [Formula 2]

In some embodiments, the composite fiber has a Formula 1 value of at least 0.62 or at least 0.69. In some embodiments, the composite fiber has a Formula 2 value of at least 70.3, at least 72.7, or at least 75.

In some embodiments, the composite fiber has all of the following characteristics: a carbon content of at least 29 wt %, a Formula 1 value of at least 0.62, and a Formula 2 value of at least 70.3. In some embodiments, the composite fiber has all of the following characteristics: a carbon content of at least 37 wt %, a Formula 1 value of at least 0.69, and a Formula 2 value of at least 72.7. In some embodiments, the composite fiber has all of the following characteristics: a carbon content of at least 39 wt %, a Formula 1 value of at least 0.69, and a Formula 2 value of at least 72.7. In some embodiments, the composite fiber has all of the following characteristics: a carbon content of at least 46 wt %, a Formula 1 value of at least 0.69, and a Formula 2 value of at least 75. When these conditions are met, the composite fiber is able to provide high half-cell FCE (e.g., at least 70.5%, at least 73%, or at least 75%). Silicon typically has poor FCE, i.e., a great portion (1-FCE) of lithium ions transported to the silicon-containing electrode during its 1^{st} cycle lithiation becomes irreversible in the following delithiation step. FCE improvement of silicon active material is critical for increasing energy density of Li-ion battery cell containing silicon in one of its electrodes. When the composite fiber is incorporated into a full battery, this loss of active material occurs at both the anode (including the composite fibers) and the cathode, and once the material is no longer active, the battery must carry this dead weight for the remainder of its usable life. As such, increasing FCE as much as possible is very important to achieve good energy density and even small improvements in FCE can yield vastly better battery performance (e.g., longer range for an EV).

In one or more embodiments, the composite fiber may also contain amorphous or crystalline silicon oxide, SiOₓ (x≤2). The composite may also contain other impurities, such as aluminum (Al), magnesium (Mg), chlorine (Cl), sodium (Na), nitrogen (N), carbon oxide (COₓ) (x≤2), and/or hydrocarbon chains. In some embodiments, the composite fiber comprises 5 wt % or less, 4 wt % or less, 3 wt % or less, 2 wt % or less, or 1 wt % or less of Al. In some embodiments, the composite fiber comprises 5 wt % or less, 4 wt % or less, 3 wt % or less, 2 wt % or less, or 1 wt % or less of Mg. In some embodiments, the composite fiber comprises 40 wt % or less, 35 wt % or less, 30 wt % or less, 25 wt % or less, 20 wt % or less, 15 wt % or less, 10 wt % or less, or 5 wt % or less of amorphous or crystalline silicon oxide, SiOₓ (x≤2).

In one or more embodiments, the composite fiber of the present disclosure has a BET specific surface area (“SSA”) of from greater than 0 to 20 m²/g, from greater than 0 to 10 m²/g, from greater than 0 to 5 m²/g, from 1 to 150 m²/g, from 5 to 150 m²/g, from 10 to 140 m²/g, from 20 to 130 m²/g, from 30 to 120 m²/g, or from 50 to 100 m²/g.

In one or more embodiments, the composite fiber has a pore volume of greater than 0 to 0.3 cm³/g, from 0.01 to 0.3 cm³/g, from greater than 0 to 0.1 cm³/g, from greater than 0 to 0.05 cm³/g, or from 0.05 to 0.25 cm³/g.

In one or more embodiments, the composite fiber has a median pore size of from 5 to 30 nm or from 10 to 20 nm.

In one or more embodiments, the composite fiber has an average diameter of from 0.1 to 10 microns, from 0.5 to 6 microns, from 1 to 8 microns, or from 2 to 5 microns.

In one or more embodiments, the composite fiber has an aspect ratio of fiber length to diameter of at least 3, at least 5, or at least 10.

The nano-crystalline silicon of the Si phase may have crystallites ranging in size from 1 to 100 nm, 1 to 50 nm, or 5 to 25 nm. In some embodiments, the Si phase comprises at least 50 wt %, at least 60 wt %, at least 70 wt %, or at least 80 wt % of nano-crystalline silicon based on a total weight of the Si phase. In other embodiments, the Si phase comprises at most 50 wt %, at most 40 wt %, at most 30 wt %, at most 20 wt %, or at most 10 wt % of nano-crystalline silicon. In some embodiments, the Si phase comprises at most 50 wt %, at most 40 wt %, at most 30 wt %, at most 20 wt %, or at most 10 wt % of amorphous or crystalline silicon oxide, SiOₓ (x≤2). In other embodiments, the Si phase comprises at least 50 wt %, at least 60 wt %, at least 70 wt %, or at least 80 wt % of amorphous or crystalline silicon oxide, SiOₓ (x≤2). In some embodiments, the Si phase consists of nano-crystalline silicon, amorphous silicon, and amorphous or crystalline silicon oxide, SiOₓ (x≤2).

The C phase may have crystallites ranging in size from 1 to 100 nm, 1 to 50 nm, or 5 to 20 nm. In some embodiments, the C phase comprises at least 50 wt %, at least 60 wt %, at least 70 wt %, or at least 80 wt % of crystalline carbon based on a total weight of the C phase. In other embodiments, the C phase comprises at most 50 wt %, at most 40 wt %, at most 30 wt %, at most 20 wt %, or at most 10 wt % of crystalline carbon. In some embodiments, the C phase comprises at most 50 wt %, at most 40 wt %, at most 30 wt %, at most 20 wt %, or at most 10 wt % of amorphous carbon. In other embodiments, the C phase comprises at least 50 wt %, at least 60 wt %, at least 70 wt %, or at least 80 wt % of amorphous carbon. In some embodiments, the C phase consists of crystalline carbon and amorphous carbon.

In one or more embodiments, one of the Si phase or the C phase has a crystalline content of greater than 50 wt % while the other of the Si phase or the C phase has a crystalline content of less than 50 wt %, based on a weight of the respective phase. In some embodiments, one of the Si phase or the C phase has a crystalline content of greater than 60 wt % while the other of the Si phase or the C phase has a crystalline content of less than 40 wt %. In some embodiments, one of the Si phase or the C phase has a crystalline content of greater than 70 wt % while the other of the Si phase or the C phase has a crystalline content of less than 30 wt %.

In some embodiments, the composite fiber is formed by infiltrating a carbon structure with silicon. For example, the composite fiber can be formed by first making a porous carbon fiber, followed by silicon infiltration into the pore structure. The silicon infiltration can be made through a chemical vapor deposition (CVD) process using a silicon precursor gas, such as a silane or trichlorosilane. Making the porous carbon fiber may include multiple steps. For instance, first a synthetic polymer fiber may be made with polymers such as polyacrylonitrile (PAN), pitch, rayon, and resin. A carbon fiber may then be made by pyrolyzing the synthetic polymer. In order to make the carbon fiber porous, the carbon fiber may need to be treated by activation or chemical exfoliation. In an activation method, the porous structure of the carbon fiber is formed by heat treating (e.g., at 700 to 1000° C.) the carbon fiber under an oxidizing atmosphere. In the chemical exfoliation method, the carbon fiber may be treated with an exfoliant, such as an acid, and an electric charge may be applied to the fiber. Alternatively, a polymer blend, for example PAN mixed with polymethylmethacrylate (PMMA), may be fiberized into a polymer fiber, which is then oxidized and phase-separated. PMMA may then be removed by pyrolysis, leaving behind a porous carbon fiber.

In some embodiments, after the porous carbon fiber (C phase) is infiltrated with silicon (Si phase), the composite fiber may be further coated with a carbon material. The carbon coating may act to protect the exposed portions of the Si phase from solid-electrolyte interphase (SEI) formation, as the SEI reduces FCE. In some embodiments, at least 60%, at least 70%, at least 75%, at least 80%, at least 85%, at least 90%, at least 95%, or about 100% of the surface area of the composite fiber may be coated with carbon.

In some embodiments, the porous carbon fiber (C phase), prior to being infiltrated with silicon (Si phase), comprises at least 50 wt %, at least 60 wt %, at least 70 wt %, or at least 80 wt % of crystalline carbon. The porous carbon fiber may comprise at most 50 wt %, at most 40 wt %, at most 30 wt %, at most 20 wt %, or at most 10 wt % of amorphous carbon. The porous carbon fiber may comprise at most 15 wt %, at most 10 wt %, or at most 5 wt % of impurities (components other than crystalline or amorphous carbon).

In some embodiments, the porous carbon fiber is partially infiltrated with silicon and then subsequently infiltrated with carbon, such that a C—Si—C composite fiber is formed. The carbon infiltration (C infiltration phase) may act to protect the Si phase from SEI formation. In some embodiments, the C—Si—C composite fiber includes at least 20 wt %, at least 30 wt %, or at least 40 wt % of the C phase, at least 20 wt %, at least 30 wt %, or at least 40 wt % of the Si phase, and at least 5 wt %, at least 10 wt %, or at least 20 wt % of the C infiltration phase, based on a total weight of the C—Si—C composite fiber. In the C—Si—C composite fiber, the C phase and the Si phase may be as described herein. The C infiltration phase may have the same characteristics as the C phase described herein and may include amorphous carbon, crystalline carbon, or combinations thereof. In some embodiments, the Si phase is substantially or completely covered by the C phase and/or the C infiltration phase. For example, at least 60%, at least 70%, at least 75%, at least 80%, at least 85%, at least 90%, at least 95%, or about 100% of the surface area of the Si phase may be covered by the C phase and/or the C infiltration phase.

In some embodiments, the composite fiber is formed by infiltrating a silicon structure with carbon. For example, the composite fiber may be formed by first making a porous silicon fiber template (PSFT) comprising metallic silicon, followed by carbon infiltration into the pores. In order to make the PSFT, a SiO₂-containing fiber, i.e., a precursor fiber, is first made. The precursor fiber can be a silica fiber made by a sol-gel fiberization method, or by acid leaching an oxide glass fiber.

The precursor fiber is reduced to the PSFT comprising metallic silicon by, for example, magnesiothermic reduction. The PSFT is then infiltrated with carbon, for example, through a chemical vapor deposition (CVD) process with a carbonaceous source such as acetylene or using other deposition processes such as physical vapor deposition, sputtering, atomic layer deposition, or infiltrating the porous fiber first with a hydrocarbon polymer (e.g., resin, polyvinyl acetate (PVA)) and converting the polymer into carbon by pyrolysis.

The PSFT comprising metallic silicon functions as a template matrix for incorporating carbon to form the composite fiber. The metallic silicon-containing fiber may have a median pore diameter in the range of 3-50 nm, a pore volume in the range of 0.1-1.5 cm³/g, and a specific surface area in the range of 10-500 m²/g. The PSFT may have a crystalline silicon content (Si %) of 50-95 wt % and a silicon crystallite size of 5-30 nm. In some embodiments, the PSFT has an elemental silicon content (Si %) of about 50 to 90 wt %, about 60 to 90 wt %, or at least about 69 wt %. In some embodiments, the PSFT has silicon crystallites (Si crystallite size) that are about 6 to 26 nm, at least about 7 nm, at least about 8 nm, or about 8 to 25 nm. In some embodiments, the PSFT has a specific surface area (SSA) of about 120 to 400 m²/g, about 150 to 400 m²/g, about 170 to 395 m²/g, or about 200 to 350 m²/g. In some embodiments, the PSFT has a median pore diameter (pore size) of about 9 to 30 nm, about 10 to 30 nm, or about 11 to 29 nm. In some embodiments, the PSFT has a pore volume of about 0.45 to 0.95 cm³/g or about 0.5 to 0.9 cm³/g.

In some embodiments, the PSFT, prior to being infiltrated with carbon, comprises at least 50 wt %, at least 60 wt %, at least 70 wt %, or at least 80 wt % of crystalline silicon (nano-crystalline silicon). The PSFT may comprise at most 50 wt %, at most 40 wt %, at most 30 wt %, at most 20 wt %, or at most 10 wt % of amorphous or crystalline silicon oxide. The PSFT may comprise at most 15 wt %, at most 10 wt %, or at most 5 wt % of impurities (components other than silicon or silicon oxide).

The material properties can be controlled through, for example, the reduction recipe design, firing temperature program, post heat treat, and/or firing oven design. For example, crystalline silicon content (Si %), Si crystallite size, pore volume, and pore diameter each typically increase with the Mg/SiO₂ ratio of the raw materials. The specific surface area (SSA), on the other hand, is related to both the Si % and the crystallite size; specifically, the SSA increases with Si %, but decreases with increasing Si crystallite size, while both Si % and Si crystallite size are influenced by the recipe, especially the Mg/SiO₂ ratio. The Si crystallite size, SSA, pore volume, and pore size can be further modified by adjusting the temperatures used as well as the amount of moderator. The exothermic heat generated during the reaction between SiO₂ and Mg is absorbed by the moderator in the batch. As the ratio of moderator to Mg decreases, the temperature rise of the batch increases during the exothermic reaction, which promotes the growth of Si crystallite, increases sintering, and decreases the SSA and pore volume. A higher holding temperature for the batch has a similar effect as the moderator on the crystallite size, SSA and pore volume.

In one or more embodiments, to form the composite fiber, the PSFT is infiltrated with carbon. In such embodiments, the Si—C composite fiber may have a carbon content of 25 to 65 wt %, at least 29 wt %, at least 35 wt %, at least 37 wt %, at least 39 wt %, at least 46 wt %, 29 to 63 wt %, 39 to 63 wt %, or 46 to 63 wt %, with 1^{st} cycle coulombic efficiency (FCE) of 60-85% and 1^{st} cycle specific delithiation capacity (1SDC) of 800-2200 mAh/g in a half-cell test.

In one or more embodiments, the majority of the elements in the composite fiber are, for example, at least 50 wt %, at least 60 wt %, at least 70 wt %, at least 80 wt %, at least 90 wt %, at least 95 wt %, at least 99 wt %, or at least 99.5 wt % of Si, C, and oxygen (O).

According to embodiments of the present disclosure, the composite Si—C fibers are able to provide superior properties as compared with simple mixtures of Si fiber and carbon materials (e.g., carbon black or graphite). Without being bound by theory, this is believed to be at least in part due to the electron and lithium-ion transport and diffusion rate being improved because of the interconnected carbon network in the fiber. Electrons and lithium ions have a higher diffusion rate in carbon than silicon. The interconnected carbon network in the composite fiber facilitates the transport of electrons and lithium ions from an outer surface of the composite fiber to the interior of the composite fiber or the transport from the interior of the composite fiber to the outer surface of the composite fiber. Therefore, the number of electrons and lithium ions as well as their transport rate increases with the carbon content in the fiber.

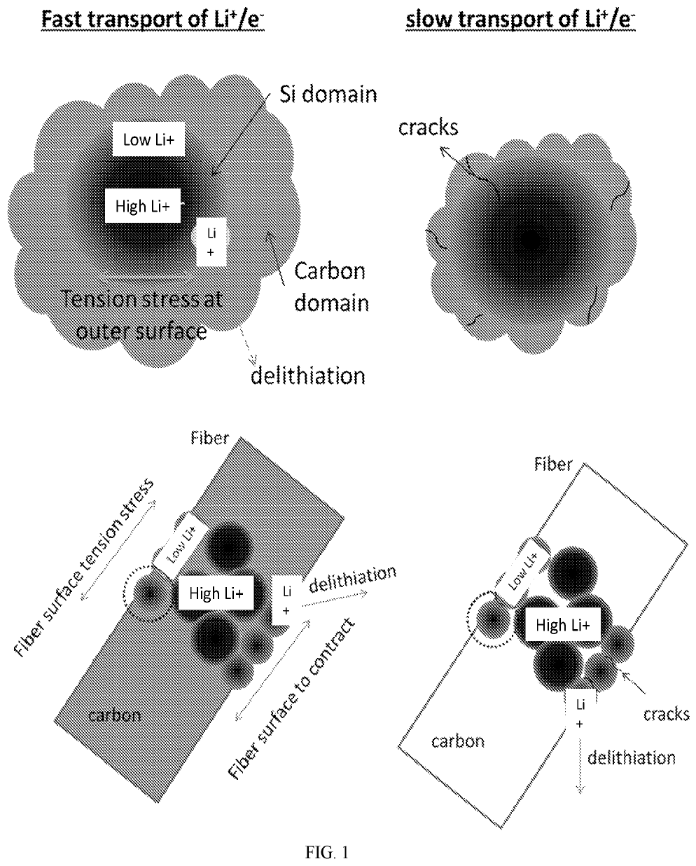

The diffusion rate improvement also reduces the exposure time of tension stress buildup on the surface of the Si domain in the delithiation step, which helps avoid the cracking of silicon domains (see upper left panel of FIG. 1 compared to upper right panel). The rate improvement also helps reduce the exposure time of tension stress buildup of the fiber surface in the delithiation step, and thus avoids the cracking of the fiber surface (see lower left panel of FIG. 1 compared to lower right panel).

In some embodiments, the composite fiber may comprise lithium wherein the lithium and at least a portion of the silicon from the Si phase form an LiₓSi alloy where x is from greater than 0 to 4. In some embodiments, the lithium-containing composite fiber further comprises Li₂SiO₃. In some embodiments, the lithium-containing composite fiber may be formed by making a nanoporous fibrous structure of one of silicon or carbon, subsequently infiltrating the structure with the other of carbon or silicon, and then reacting the infiltrated structure with a lithium source to form the LiₓSi alloy. In other embodiments, the lithium-containing composite fiber may be formed by making a nanoporous fibrous structure of silicon, then reacting the structure with a lithium source to form the LiₓSi alloy, and finally infiltrating the structure with carbon. In yet other embodiments, the lithium-containing composite can be formed by introducing lithium into a Si—C composite fiber to form the LiₓSi alloy.

### EXAMPLES

### Example 1

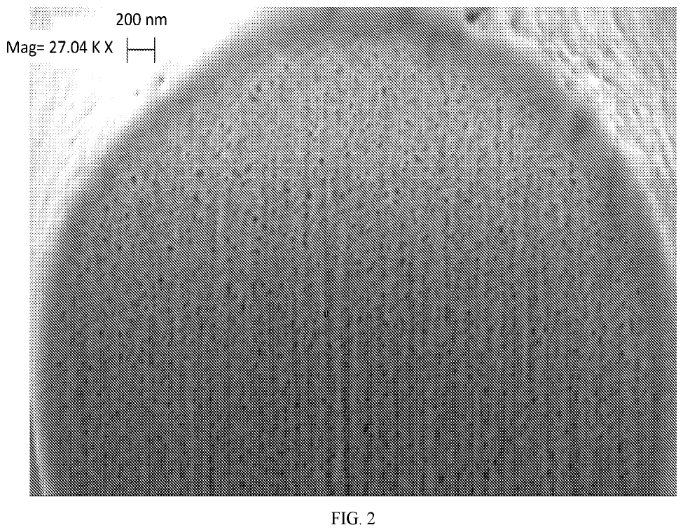

A PSFT was formed by magnesiothermic reduction followed by acid washing to remove the undesired reaction products and analyzed as detailed below. FIG. 2 is an SEM image of the cross-section of the PSFT comprising metallic silicon. Pores on the order of tens of nanometers in diameter can be observed. The PSFT in FIG. 2 was also analyzed by x-ray diffraction (XRD) which indicated that the PSFT comprises crystalline silicon, in the range of 50 to 95 wt %, and amorphous silicon oxide (SiOx), in the range of 5 to 50 wt %, determined by Rietveld analysis. The amorphous silicon oxide in the PSFT is either stoichiometric (SiO₂) or nonstoichiometric, SiOₓ where x<2.

### Example 2

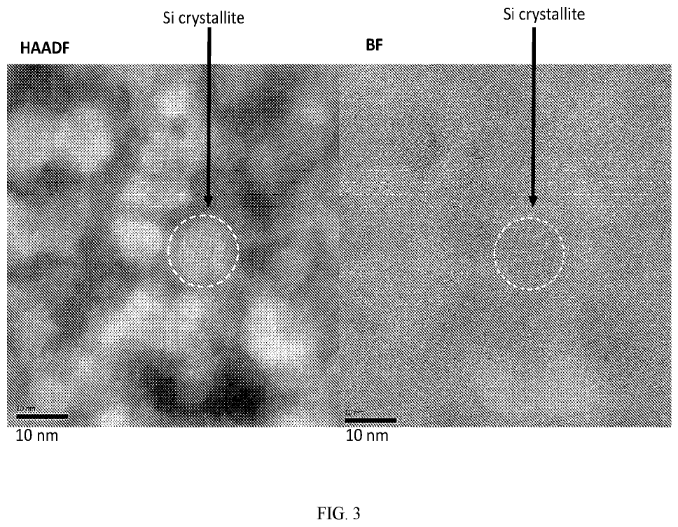

The PSFT from Example 1 was infiltrated with carbon and analyzed as detailed below. FIG. 3 shows the STEM images of the Si—C composite fiber, in which the Si crystallites, carbon and SiOx form an interconnected and porous network. XRD of the composite fiber shows the carbon is mostly amorphous, or exhibits weakly ordered structure, resembling that of carbon black. In some cases, chemical bonding at the interface between Si and C may be formed. That is, a SiC compound (silicon carbide) may be formed at the interface.

Typical silicon crystallite size may be in the range of 5 to 30 nm in diameter, determined by either Rietveld analysis or Scherrer analysis of the XRD peaks of silicon, or direct measurement of the crystallites in the STEM images. FIG. 3 shows the STEM images of the Si—C composite, where the HAADF (High-angle angular dark field) image shows the morphology of the grains in the fiber, and the bright field (BF) image shows the periodic fringes, indicating that the grains in the HAADF image are mostly single crystalline silicon, i.e., crystallite. When the shape of the silicon crystallite is irregular, the longer axis of the particle is defined as the diameter.

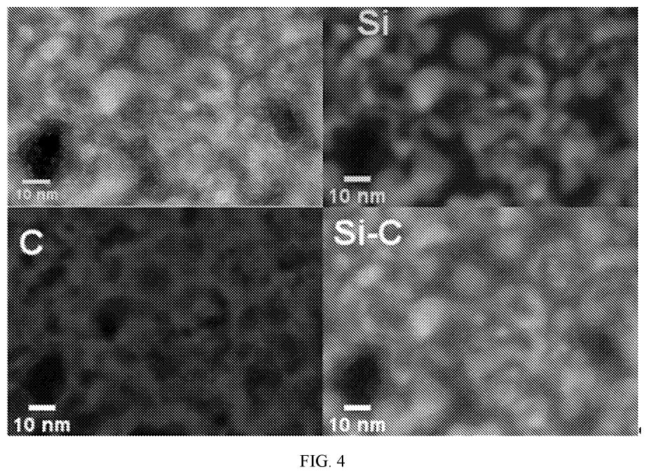

FIG. 4 shows the elemental mapping of Si (top right) and C (bottom left) in the Si—C composite fiber by STEM-EELS. Si and C are complementary in the fiber structure, as shown in the overlaid elemental mapping images of Si and C (bottom right). This indicates that the carbon has infiltrated into the porous space in the Si fiber template and is in close contact with the Si crystallites. The silicon crystallites are interconnected via connections to neighboring silicon crystallites or amorphous silicon oxide. Therefore, it is confirmed that the initial PSFT is a porous network of interconnected silicon and silicon oxide.

### Example 3

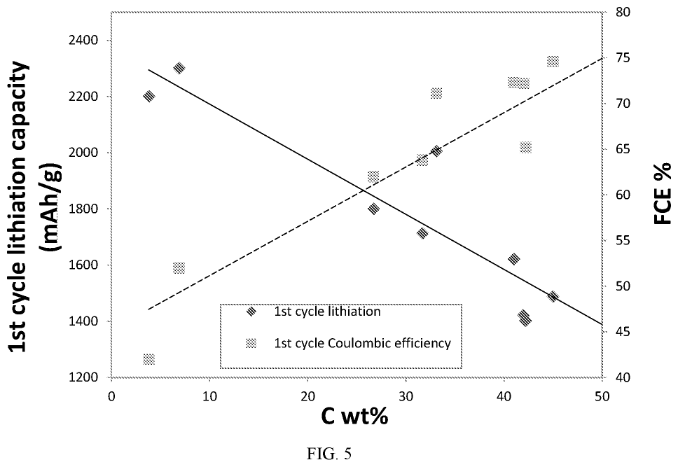

A number of samples were made from the same PSFT but infiltrated with different amounts of carbon. FIG. 5 shows the relationship between 1^{st} cycle specific lithiation capacity, FCE, and C % for the samples. The results show that, for a specific PSFT, the specific lithiation capacity tends to decrease as the C % increases.

### Example 4

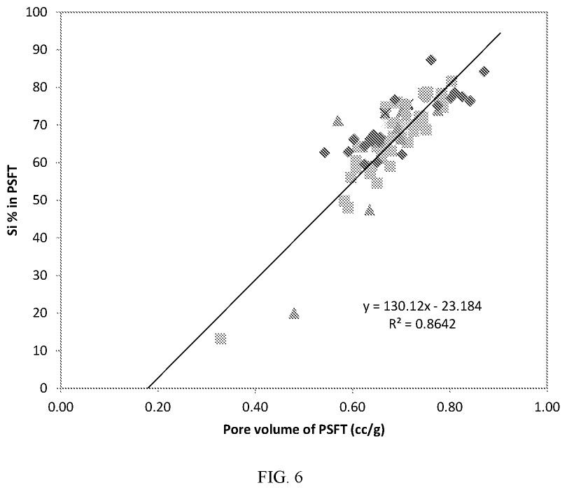

PSFTs having varying pore volumes were prepared and infiltrated with carbon to form composite fibers. The pore volume and Si % in the PSFTs are shown in FIG. 6. The amount of carbon that can be infiltrated into the PSFTs is generally limited by a pore volume of the PSFTs, i.e., the void space accessible to the carbon. Higher pore volume allows more carbon to infiltrate, thus resulting in a higher possible carbon content.

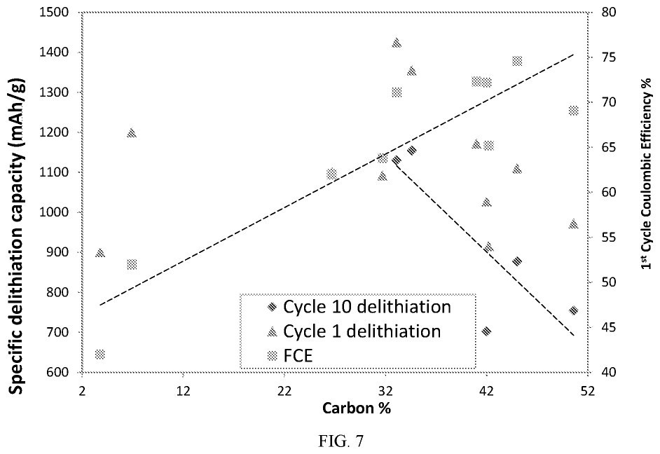

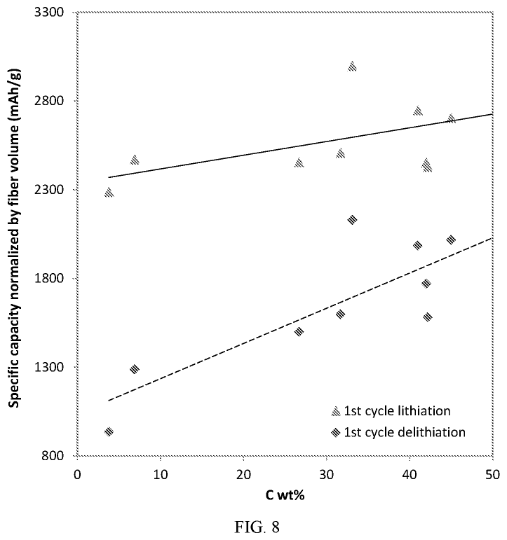

The composite fibers were then formed into half cells and tested. The results are shown in FIG. 7 and FIG. 8. As carbon or silicon is infiltrated into the PSFT or carbon fiber, the total volume of the formed Si—C composite is not changed relative to the original PSFT or carbon fiber template. However, the FCE is significantly improved (e.g., from 40 to 75% as shown in FIG. 7) and the charging and discharging volumetric capacity of a single fiber is increased (as shown in the examples of FIG. 8).

### Example 5

PSFTs were formed by magnesiothermic reduction and the properties of the PSFTs were measured. The raw materials used for reduction and the measurement results are summarized in Table 1 below.

TABLE 1
PSFT Properties

| | PSFT | | | | | | | |
|---|---|---|---|---|---|---|---|---|
| | | | | Material Properties | | | | |
| | Raw materials batch | | | | Si | | | |
| | for reduction (g) | | | | crys- | | | |
| | | | Moder- | | tallite | SSA | PV | |
| | SiO₂ | | ator | | size | (m²/ | (cc/ | PD |
| | fiber | Mg | (NaCl) | Si % | (nm) | g) | g) | (nm) |
| Comp. 1 | | | | 71 | 8 | | | |
| Comp. 2 | | | | 69 | 8 | | | |
| Comp. 3 | | | | 69 | 8 | | | |
| Comp. 4 | | | | 69 | 8 | | | |
| Comp. 5 | | | | 69 | 8 | | | |
| Example 1 | | | | 61.7 | 8 | | | |
| Example 2 | 92.2 | 44.8 | 1178 | 62.4 | 7.4 | 331 | 0.63 | 11 |
| Example 3 | 45.4 | 36.7 | 1418 | 82.4 | 12.1 | 266 | 0.78 | 15.5 |
| Example 4 | 75.7 | 44.7 | 949 | 70.6 | 8.4 | 297 | 0.65 | 12 |
| Example 5 | 75.7 | 44.7 | 1380 | 70.7 | 8.1 | 339 | 0.66 | 10.5 |
| Example 6 | 87.8 | 51.8 | 1364 | 72.8 | 8.9 | 346 | 0.64 | 10.5 |
| Example 7 | | | | 61.7 | 8 | | | |
| Example 8 | 169.5 | 100 | 1234 | 76.8 | 15.3 | 216 | 0.69 | 16.7 |
| Example 9 | 97 | 75 | 1331 | 92.0 | 19.1 | 216 | 0.87 | 19.2 |
| Example 10 | 57 | 41.5 | 1402 | 83.5 | 10.6 | 297 | 0.8 | 12.5 |
| Example 11 | 61.5 | 44.8 | 1179 | 86.7 | 11.5 | 281 | 0.83 | 13 |
| Example 12 | | | | | | | | |
| Example 13 | | | | 71 | 8 | | | |
| Example 14 | 109 | 75 | 1319 | 78.6 | 14.7 | 271 | 0.81 | 15.5 |
| Example 15 | 57 | 41.5 | 1402 | 83.5 | 10.6 | 297 | 0.8 | 12.5 |
| Example 16 | | | | 69.1 | 14.2 | 205 | 0.49 | 13.5 |
| Example 17 | | | | 91.4 | 10.3 | 308 | 0.88 | 14.8 |
| Example 18 | | | | 97.0 | 17.1 | 128 | 0.67 | 28.4 |
| Example 19 | | | | 93.0 | 24.2 | | | |
| Example 20 | | | | 96.8 | 13.4 | 212 | 0.92 | 26.0 |

The materials from Table 1 were infiltrated with carbon to form Si—C composite fibers. Half coin cells were formed by pairing an electrode including the Si—C composite fibers with a lithium metal electrode and tested for FCE and 1^{st} cycle specific delithiation capacity (1SDC). The properties of the Si—C composite fibers and the half-cell testing results are summarized in Table 2 below.

TABLE 2
Half-cell FCE, 1st cycle delithiation specific capacity (1SDC)
of electrode with active materials made from various PSFT

| | Si—C composite fiber | | | | | | | | | |
|---|---|---|---|---|---|---|---|---|---|---|
| | Pore Structure | | | Composition (wt %) | | | | | Half Cell Testing | |
| | SSA | PV | PD | | | a- | Form. | Form. | FCE | 1SDC |
| | m²/g | cm³/g | nm | C % | Si % | SiOₓ % | 1 | 2 | % | mAh/g |
| Comp. 1 | | | | 0 | 71 | 29 | 0.71 | 60.6 | 52 | |
| Comp. 2 | 189 | 0.47 | 11.5 | 3.8 | 66.4 | 29.8 | 0.69 | 61.7 | 42 | 900 |
| Comp. 3 | 187 | 0.43 | 11 | 6.9 | 64.2 | 28.9 | 0.69 | 62.6 | 52 | 1200 |
| Comp. 4 | 116 | 0.24 | 10 | 26.7 | 50.6 | 22.7 | 0.69 | 68.6 | 62 | 1100 |
| Comp. 5 | 77 | 0.18 | 11.5 | 31.7 | 47.1 | 21.2 | 0.69 | 70.1 | 63.8 | 1092 |
| Example 1 | 93 | 0.24 | 13 | 33.1 | 41.3 | 25.6 | 0.62 | 70.3 | 71.1 | 1425 |
| Example 2 | 32 | 0.08 | 11.5 | 35.6 | 40.2 | 26 | 0.62 | 71.0 | 71.22 | 1058 |
| Example 3 | 77 | 0.23 | 15 | 38.1 | 51.0 | 15.4 | 0.82 | 72.5 | 70.64 | 1444 |
| Example 4 | 46 | 0.11 | 11.5 | 39.2 | 39.9 | 20.9 | 0.66 | 72.3 | 71.26 | 1227 |
| Example 5 | 44 | 0.1 | 10.5 | 39.4 | 40.4 | 20.2 | 0.67 | 72.4 | 71.93 | 1220 |
| Example 6 | 33 | 0.07 | 11 | 39.8 | 38.9 | 21.3 | 0.65 | 72.4 | 72.92 | 1220 |
| Example 7 | 20 | 0.08 | | 41 | 36.4 | 22.6 | 0.62 | 72.7 | 72.3 | 1172 |
| Example 8 | 45 | 0.18 | 18.6 | 39.3 | 46.6 | 14.1 | 0.77 | 72.7 | 74.46 | 1371 |
| Example 9 | 69 | 0.28 | 20.6 | 40.2 | 55.0 | | 0.92 | 73.5 | 73.53 | 2105 |
| Example 10 | 72 | 0.19 | 12 | 40.6 | 49.6 | 13.6 | 0.84 | 73.3 | 74.75 | 1495 |
| Example 11 | 67 | 0.17 | 12 | 41.2 | 51.0 | 13.2 | 0.87 | 73.6 | 73.08 | 1558 |
| Example 12 | 55 | 0.16 | 13.9 | 44.6 | 48.0 | 12.4 | 0.87 | 74.7 | 73.66 | 1498 |
| Example 13 | 7 | 0.05 | | 45 | 39.1 | 16 | 0.71 | 74.2 | 74.6 | 1110 |
| Example 14 | | | | 45.6 | 42.8 | 11.6 | 0.79 | 74.7 | 74.27 | 1549 |
| Example 15 | 16 | 0.05 | 17.3 | 51.8 | 40.2 | 11 | 0.84 | 76.7 | 77.96 | 1262 |
| Example 16 | 0.28 | 0.03 | 33.8 | 55 | 31.1 | 13.9 | 0.69 | 77.2 | 76.2 | 841 |
| Example 17 | 3.4 | 0.02 | 22.9 | 59.1 | 37.4 | 3.5 | 0.91 | 79.2 | 80.3 | 1193 |
| Example 18 | 11.7 | 0.07 | 28.4 | 60.2 | 38.6 | 1.2 | 0.97 | 79.8 | 79.2 | 860 |
| Example 19 | 4 | 0.03 | 29.4 | 61.6 | 35.7 | 2.7 | 0.93 | 80.0 | 81.9 | 879 |
| Example 20 | | | | 62.3 | 36.5 | 1.2 | 0.97 | 80.4 | 80.4 | 1452 |

As shown above, when the composite fibers had all of the following characteristics: a carbon content of at least 29 wt %, a Formula 1 value of at least 0.62, and a Formula 2 value of at least 70.3, the FCE was greater than 73%. Additionally, when the composite fibers had all of the following characteristics: a carbon content of at least 37 wt %, a Formula 1 value of at least 0.69, and a Formula 2 value of at least 72.7, the FCE was greater than 73%. Further, when the composite fiber had all of the following characteristics: a carbon content of at least 46 wt %, a Formula 1 value of at least 0.69, and a Formula 2 value of at least 75, the FCE was greater than 75%. Conversely, although Comparative Example 5 had a Formula 1 value 0.69 and a carbon content of 31.7 wt %, its Formula 2 value was only 70.1. As a result, Comparative Example 5 only achieved an FCE of 63.8%.

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

1. A composite fiber comprising:
a porous silicon phase comprising elemental silicon;
a porous carbon phase comprising elemental carbon;
wherein the silicon phase and the carbon phase form an intertwined network structure in the composite fiber such that each of the silicon phase and the carbon phase is interconnected and continuous throughout the composite fiber;
wherein the silicon phase and the carbon phase together constitute at least 50 wt % of the composite fiber;
wherein the elemental carbon constitutes at least 29 wt % of the composite fiber based on a total weight of the composite fiber; and
wherein, based on a total weight of the composite fiber, a wt % of the elemental carbon in the composite fiber is represented by Xc and a wt % of the elemental silicon in the composite fiber is represented by Xsi, and the following formulae are met:
Xsi/(100-Xc)≥0.62
0.3025*Xc+3.70*Xsi/(100-Xc)+57.97≥70.3.

2. The composite fiber of claim 1, wherein elemental carbon constitutes at least 37 wt % of the composite fiber and (0.3025*Xc+3.70*Xsi/(100-Xc)+57.97) is at least 72.7.

3. The composite fiber of claim 1, wherein elemental carbon constitutes at least 46 wt % of the composite fiber and (0.3025*Xc+3.70*Xsi/(100-Xc)+57.97) is at least 75.

4. The composite fiber of claim 1, wherein the silicon phase comprises silicon crystallites having a size of 6 to 25 nm; and
wherein the silicon phase comprises at least 50 wt % of crystalline silicon based on a total weight of the silicon phase.

5. The composite fiber of claim 1, wherein the composite fiber has a pore volume of greater than 0 to 0.3 cm³/g.

6. The composite fiber of claim 1, wherein the composite fiber has a median pore size of from 5 to 30 nm.

7. The composite fiber of claim 1, wherein the composite fiber has an average diameter of from 0.1 to 10 microns and an aspect ratio of fiber length to diameter of at least 3.

8. The composite fiber of claim 1, wherein the carbon phase comprises crystallites ranging in size from 1 to 100 nm.

9. The composite fiber of claim 8, wherein the carbon phase comprises at least 50 wt % of crystalline carbon based on a total weight of the carbon phase.

10. The composite fiber of claim 1, further comprising lithium, wherein the lithium and at least a portion of the silicon from the silicon phase form an LiₓSi alloy where x is from greater than 0 to 4.

11. A method comprising:
forming a porous fiber template comprising one of elemental carbon or elemental silicon; and
infiltrating the porous fiber template with an infiltrating phase comprising the other of elemental carbon or elemental silicon to form a composite fiber;
wherein the porous fiber template phase and the infiltrating phase form an intertwined network structure in the composite fiber such that each of the porous fiber template and the infiltrating phase is interconnected and continuous throughout the composite fiber;
wherein the elemental silicon and the elemental carbon together constitute at least 50 wt % of the composite fiber;
wherein the elemental carbon constitutes at least 29 wt % of the composite fiber based on a total weight of the composite fiber; and
wherein, based on a total weight of the composite fiber, a wt % of the elemental carbon in the composite fiber is represented by Xc and a wt % of the elemental silicon in the composite fiber is represented by Xsi, and the following formulae are met:
Xsi/(100-Xc)≥0.62
0.3025*Xc+3.70*Xsi/(100-Xc)+57.97≥70.3.

12. The method of claim 11, wherein the porous fiber template comprises elemental carbon.

13. The method of claim 11, wherein the porous fiber template comprises elemental silicon.

14. The method of claim 11, wherein a median pore diameter of the infiltrating phase is from 0.1 to 5 nm less than a median pore diameter of the porous fiber template.

15. The method of claim 11, wherein infiltrating the porous fiber template comprises chemical vapor deposition, physical vapor deposition, sputtering, atomic layer deposition, or pyrolysis.

16. The method of claim 11, wherein the porous fiber template comprises 50 to 95 wt % of crystalline silicon or crystalline carbon, wherein the crystalline silicon or crystalline carbon has a crystallite size of from 6 to 25 nm.

17. The method of claim 11, wherein the porous fiber template has a BET specific surface area of 150 to 400 m²/g, a median pore diameter of from 8 to 30 nm, and a pore volume of from 0.5 to 0.9 cm³/g.

18. The method of claim 11, further comprising:
reacting the composite fiber with a lithium source to form a LiₓSi alloy; or
wherein the porous fiber template comprises elemental silicon, reacting the porous fiber template with a lithium source to form a LiₓSi alloy prior to infiltrating.

19. An electrode active material comprising the composite fiber of claim 1.

20. An electrode comprising the electrode active material of claim 19.
